(19) United States
(12) Patent Application Publication
(10) Pub. No.: US 2005/0144161 A1
(43) Pub. Date: Jun. 30, 2005

(54) Information processing device and method for controlling the same

(75) Inventor: Makoto Hirota, Tokyo (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Tokyo (JP)

(21) Appl. No.: 11/005,268

(22) Filed: Dec. 6, 2004

(30) Foreign Application Priority Data
Dec. 11, 2003 (JP) 2003-413836

(51) Int. Cl. G06F 17/30

(52) U.S. Cl. 707/3

(57) ABSTRACT

An information processing device, a method for controlling the information processing device, an information processing system, and a program that achieves more flexible cooperation among devices are provided. A query-information creating unit creates query information for searching for a collaborative function with a peripheral device. A communications unit transmits the query information to a peripheral device on a network and receives a search result for the query information from the peripheral device on the network. A UI-component creating unit creates a user interface component to operate the collaborative function with the peripheral device based on the received search result. A UI updating unit updates the user interface based on the created user interface component.

### BACKGROUND OF THE INVENTION

1. Field of the Invention

The present invention relates to an information processing device, a method for controlling the information processing device, and a program in an information processing system that includes a user interface device and a peripheral device connected to each other via a network. In particular, the present invention relates to an information processing device for creating a user interface for operating the peripheral device connected to the information processing device via the network and accepting operations for the peripheral device from the user interface device connected to the information processing device via the network, wherein the peripheral device holds information describing its own functions and user interface information for the functions.

2. Description of the Related Art

Recently, a variety of information equipment has been developed. Such information equipment includes home information appliances, such as mobile phones, digital cameras, car navigation systems, and office equipment, such as copiers and printers. In addition, in accordance with the widespread use of the Internet, wired or wireless connection interface technologies, such as USB (universal serial bus) or Bluetooth, and collaboration of the variety of information equipment via a network, new features and new services have been developed.

For example, images captured by a digital camera can be directly printed by a printer via a USB cable without the use of a terminal, such as a personal computer (PC). Additionally, it is technically possible for a mobile phone to directly collaborate with an automatic vending machine, and a product in the vending machine can be purchased by operating the mobile phone.

For cooperative services among devices, in order to start the service and carry out various operations, such as settings for the service, at least a user interface for the operation is required.

For example, in the case of direct printing, a graphic user interface displayed on an LCD screen of a digital camera includes various user interface components, such as a button used for a “print” operation. Also, user interface components for setting various print parameters, such as an output paper size, are required.

In a known technology, a user interface for a cooperative operation with another device is pre-installed in a device carrying out the operation. For example, in the case of direct printing, the user interface is pre-installed in a digital camera. That is, in a development phase of the digital camera, it is assumed that the digital camera will be used to carry out direct printing in cooperation with a printer, and, based on this assumption, a user interface is installed.

For example, Japanese Patent Laid-Open No. 10-065867 discloses a configuration in which information on a user interface for direct-print operations between a digital imaging device and an external printing device is all managed by the digital imaging device.

As described above, in the known technology, a user interface of an operational device to carry out cooperation between the devices is designed and installed assuming a certain target collaborative function. Therefore, the user interface cannot support a dynamic collaborative function not covered by this assumption.

For example, in the case of direct printing, the paper sizes that a printer supports are determined in advance. Accordingly, a user interface component of a digital camera for selecting a paper size is implemented so that one of the supported paper sizes can be selected. However, when a printer that supports another paper size is developed and the digital camera carries out direct printing on that printer, the digital camera cannot present a user interface component to select the new paper size.

In another example, although digital TVs capable of receiving and displaying an image from a digital camera are being developed, existing digital cameras have no user interface to cooperate with digital TVs since those digital cameras have no knowledge of functions for displaying images on digital TVs in cooperation with the digital TVs.

Consequently, the digital cameras have no user interface component to select, for example, a menu item “display on a TV”. That is, although a communication interface that allows for cooperation between a digital camera and a digital TV has been developed, users cannot use a collaborative function therebetween since the digital camera has no user interface for that function.

### SUMMARY OF THE INVENTION

The present invention provides an information processing device, a method for controlling the information processing device, an information processing system, and a program that achieves more flexible cooperation among devices.

According to an aspect of the present invention, an information processing device includes transmitting means for transmitting query information for searching for a collaborative function with a peripheral device to the peripheral device, receiving means for receiving a search result for the query information from the peripheral device, creating means for creating a user interface component to operate the collaborative function with the peripheral device based on the search result received by the receiving means, and update means for updating the user interface based on the user interface component created by the creating means.

According to another aspect of the present invention, an information processing device accepts an operation from a user interface device connected via a network. The information processing device includes receiving means for receiving query information for searching for a collaborative function with the user interface device from the user interface device on the network, holding means for holding function information describing support functions of the information processing device in association with the corresponding user interface information, searching means for searching for a combination of functions being cooperative with the user interface device based on the query information received by the receiving means by referring to the holding means, and transmitting means for transmitting information about the combination of functions being cooperative with the user interface device searched by the searching means to the user interface device on the network.

According to another aspect of the present invention, an information processing system includes a user interface device and a peripheral device connected to the user interface device via a network. The user interface device includes query-information creating means for creating query information for searching for a collaborative function with the peripheral device, user interface device transmitting means for transmitting the query information to the peripheral device on the network, user interface device receiving means for receiving a search result for the query information from the peripheral device on the network, creating means for creating a user interface component to operate the collaborative function with the peripheral device based on the search result received by the user interface device receiving means, and update means for updating an the interface based on the user interface component created by the creating means. The peripheral device includes peripheral device receiving means for receiving the query information from the user interface device on the network, searching means for searching for a combination of functions being cooperative with the user interface device based on the query information received by the peripheral device receiving means by referring to holding means, and peripheral device transmitting means for transmitting information about the combination of functions being cooperative with the user interface device to the user interface device on the network as a search result searched by the searching means.

According to yet another aspect of the present invention, a method for controlling an information processing device includes steps of transmitting query information for searching for a collaborative function with a peripheral device to the peripheral device, receiving a search result for the query information from the peripheral device, creating a user interface component to operate the collaborative function with the peripheral device based on the search result received, and updating the user interface based on the user interface component created.

According to an aspect of the present invention, a program includes program code for performing steps on an information processing device as described above.

According to still another aspect of the present invention, a method for controlling an information processing device for accepting an operation from a user interface device connected via a network includes steps of receiving query information for searching for a collaborative function with the user interface device from the user interface device on the network, searching for a combination of functions being cooperative with the user interface device based on the query information received by referring to a recording medium for recording function information describing support functions of the information processing device in association with the corresponding user interface information, and transmitting information about the combination of functions being cooperative with the user interface device searched to the user interface device on the network.

According to another aspect of the present invention, a program controls an information processing device according to the steps described above.

According to the present invention, an information processing device, a method for controlling the information processing device, an information processing system, and a program that achieves more flexible cooperation among devices can be provided.

Further features and advantages of the present invention will become apparent from the following description of exemplary embodiments with reference to the attached drawings.

### BRIEF DESCRIPTION OF THE DRAWINGS

FIG. 1 is a block diagram of an information processing system according to a first embodiment of the present invention.

FIG. 2 is a diagram of the functional structure of a digital camera according to the first embodiment of the present invention.

FIG. 3 is a diagram of a functional structure of a copier according to the first embodiment of the present invention.

FIG. 4 shows the hardware configuration of a digital camera according to the first embodiment of the present invention.

FIG. 5 shows the hardware configuration of the copier according to the first embodiment of the present invention.

FIG. 6 shows the hardware configuration of a printer according to the first embodiment of the present invention.

FIG. 7 is a flow chart of the operation of the information processing system according to the first embodiment.

FIGS. 8A and 8B show examples of a graphic user interface realized on the digital camera according to the first embodiment of the present invention.

FIG. 9 shows an example of query information transmitted from the digital camera to other peripheral devices according to the first embodiment of the present invention.

FIG. 10 shows an example of an HTTP description of the query information transmitted from the digital camera to other peripheral devices according to the first embodiment of the present invention.

FIGS. 11A and 11B show examples of graphic user interfaces on the digital camera for setting parameters of a peripheral device according to the first embodiment of the present invention.

FIG. 12 is a block diagram of an information processing system according to a second embodiment of the present invention.

FIG. 13 is a diagram of the functional structure of a PC according to the second embodiment of the present invention.

FIG. 14 is a diagram of the functional structure of a scanner according to the second embodiment of the present invention.

FIG. 15 shows the hardware configuration of the PC according to the second embodiment of the present invention.

FIG. 16 shows the hardware configuration of the scanner according to the second embodiment of the present invention.

FIG. 17 is a flow chart of the operation of the information processing system according to the second embodiment of the present invention.

FIGS. 18A and 18B show examples of a graphic user interface realized on the PC according to the second embodiment of the present invention.

FIG. 19 shows an example of query information transmitted from the PC to other peripheral devices according to the second embodiment of the present invention.

FIG. 20 shows an example of an HTTP description of the query information transmitted from the PC to other peripheral devices according to the second embodiment of the present invention.

FIG. 21 shows an example of a graphic user interface on the PC for setting parameters of a peripheral device according to the second embodiment of the present invention.

FIGS. 22A to 22D show an example of an HTTP response from a copier according to the second embodiment of the present invention.

FIGS. 23A to 23D show an example of a description of function information of the copier according to the first embodiment of the present invention.

FIG. 24 shows an example of a description of function information of the printer according to the first embodiment of the present invention.

FIG. 25 shows an example of an HTTP response from the copier according to the first embodiment of the present invention.

FIG. 26 shows an example of an HTTP response from the printer according to the first embodiment of the present invention.

FIG. 27 shows an example of a description of function information of the scanner according to the second embodiment of the present invention.

FIG. 28 shows an example of an HTTP response from the scanner according to the second embodiment of the present invention.

### DESCRIPTION OF THE EMBODIMENTS

Embodiments of the present invention will be described below in detail with reference to the accompanying drawings.

### First Embodiment

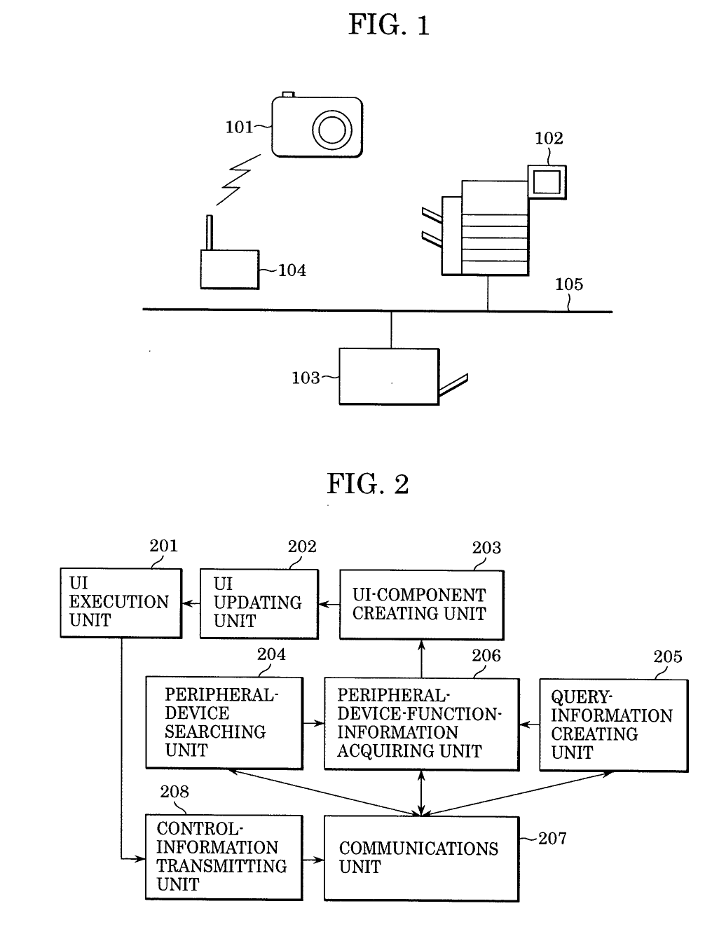

In a first embodiment, as shown in FIG. 1, a digital camera 101 having a wireless LAN interface can access a wired LAN 105 via a wireless base station 104 and can operate a copier 102 or a printer 103 on the wired LAN 105.

FIG. 1 is a block diagram of an information processing system according to the first embodiment of the present invention. The information processing system includes the digital camera 101, the copier 102, the printer 103, the wireless base station 104, and the wired LAN 105. According to the present invention, the digital camera 101 functions as a user interface device capable of dynamically creating a user interface that can operate a peripheral device on the wired LAN 105, namely, the copier 102 or the printer 103.

In FIG. 1, the LAN 105 is a wired LAN. However, the LAN 105 is not limited to a wired LAN. For example, the LAN 105 may be replaced with a communications network, such as the Internet, a WAN (wide area network), a telephone network, a dedicated digital communication network, an ATM (asynchronous transfer mode) network, a frame relay network, a communication satellite network, a cable TV network, and a data broadcast wireless network to transmit and receive data. Alternatively, the LAN 105 may be replaced with a combination of the above-described communication networks to transmit and receive data.

A functional structure of the digital camera 101 will be described next with reference to FIG. 2. FIG. 2 is a diagram of the functional structure of the digital camera 101 according to the first embodiment of the present invention. In the functional structure of the digital camera 101, a user interface (UI) execution unit 201 displays an output to a user and receives an input from the user. A UI updating unit 202 updates a UI in cooperation with a peripheral device. A UI-component creating unit 203 creates UI components corresponding to the collaborative function with the peripheral device. A peripheral-device searching unit 204 searches the network for a peripheral device capable of communicating with the digital camera 101 itself. A query-information creating unit 205 creates query information for searching the peripheral devices on the network for a function that can cooperate with the digital camera 101 itself.

As used herein, the query information refers to information for the digital camera 101, which is a user interface device, to search for a peripheral device for which the digital camera 101 can dynamically create a user interface to operate it. For example, the query information includes at least one of the operation type of a peripheral device, an operation target, various types of setting parameters, and output information of an operational result.

A peripheral device function information acquiring unit 206 transmits the query information created by the query-information creating unit 205 to peripheral devices capable of communicating with the digital camera 101 and acquires information about functions that a cooperative peripheral device can provide as a search result. A communications unit 207 carries out communication on a wireless LAN in the first embodiment. A control-information transmitting unit 208 transmits control information of the collaborative function, which is received from a user operation, to the peripheral device.

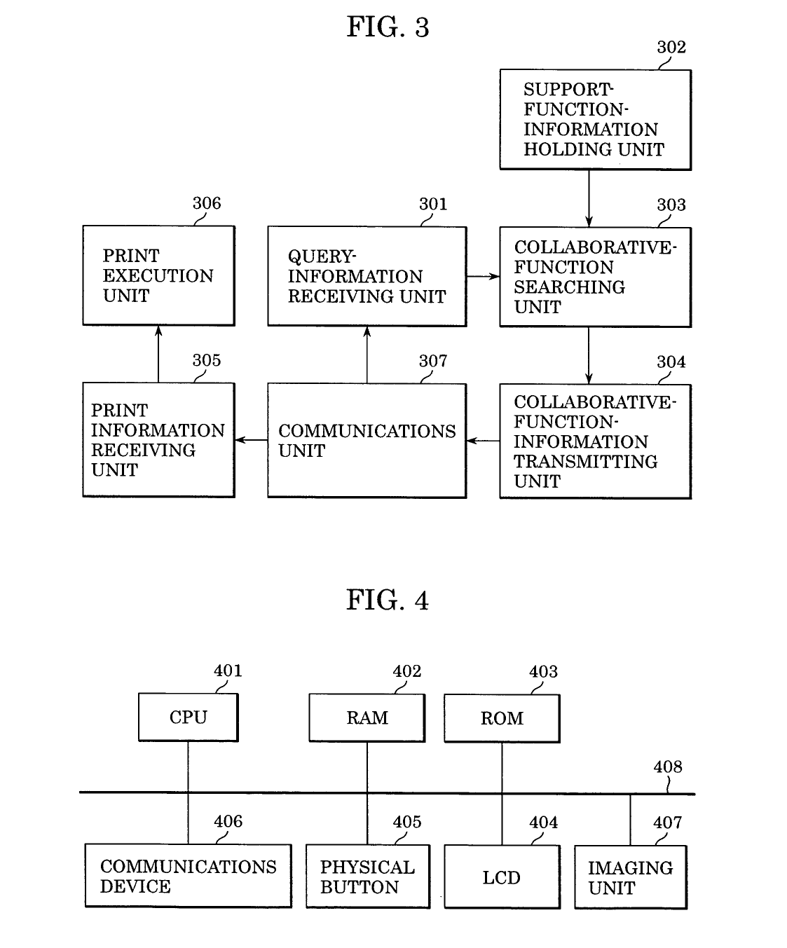

The functional structure of the copier 102 will be described next with reference to FIG. 3. FIG. 3 is a diagram of a functional structure of the copier 102 according to the first embodiment of the present invention. Additionally, the printer 103 has the same functional structure as that shown in FIG. 3. A query-information receiving unit 301 receives the query information created by the query-information creating unit 205 from another apparatus (the digital camera 101 in the first embodiment) via a communications unit 307.

A support-function information holding unit 302 holds function information of the copier 102. The function information includes, for example, at least one of the operation type of a peripheral device, the operation target, various setting parameters, and output information of an operational result of the copier 102, which is a peripheral device. The support-function information holding unit 302 holds user interface information corresponding to the function as well as the function information. The user interface information is used for the user interface device to create a user interface for allowing the operation of the copier 102.

A collaborative-function searching unit 303 searches for a function that can cooperate by matching the query information from another device (the digital camera 101 in the first embodiment) received by the query-information receiving unit 301 with the support function information held by the support-function information holding unit 302. A collaborative-function-information transmitting unit 304 transmits the search result from the collaborative-function searching unit 303 to a sender of the query information (the digital camera 101 in the first embodiment). A print information receiving unit 305 receives control information for controlling printing from the control-information transmitting unit 208. A print execution unit 306 carries out printing based on the print information received by the print information receiving unit 305. A communications unit 307 carries out communication over the wired LAN 105 in the first embodiment.

The hardware configuration of the digital camera 101 will be described next with reference to FIG. 4. FIG. 4 shows the hardware configuration of the digital camera 101 according to the first embodiment of the present invention. A CPU (central processing unit) 401 operates in accordance with a program that defines an operation procedure of the digital camera 101, as will be described below. A RAM (random-access memory) 402 provides a memory area required for the operation of the program. A ROM (read-only memory) 403 holds the program for carrying out the above-described operation procedure. An LCD (liquid crystal display) 404 displays a graphic user interface (GUI) and a captured image. A user carries out a variety of inputs into the digital camera 101 by operating a physical button 405. As well as a simple push button, the physical button 405 includes an arrow key, which will be described below. In the first embodiment, a communications device 406 is a wireless LAN card. An imaging unit 407 includes an optical system and a CCD (charge-coupled device) to capture the image of a subject. A bus 408 connects the above-described components of the digital camera 101 to each other.

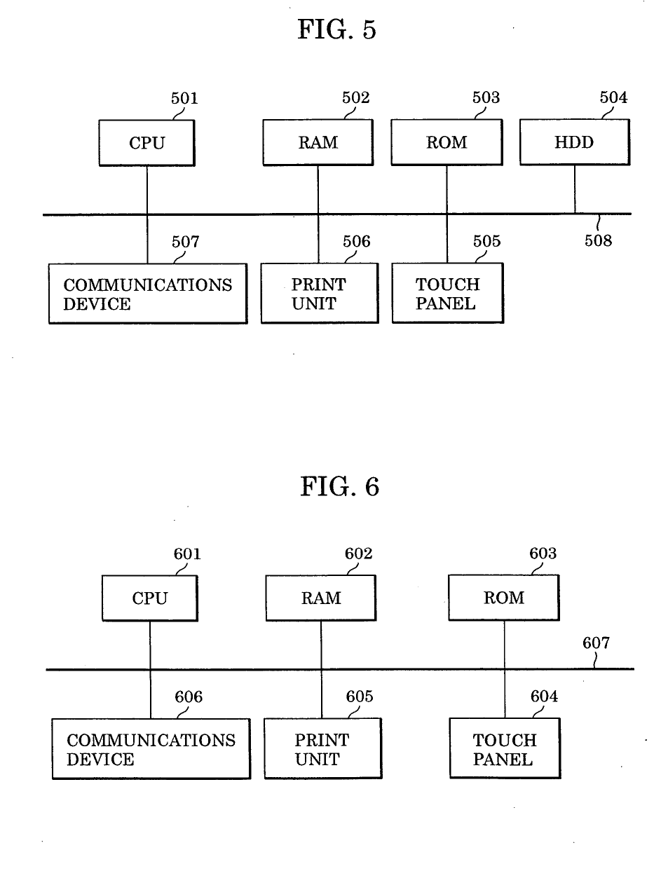

The hardware configuration of the copier 102 will be described next with reference to FIG. 5. FIG. 5 shows the hardware configuration of the copier 102 according to the first embodiment of the present invention. A CPU 501 operates in accordance with a program that defines an operation procedure of the copier 102, as will be described below. A RAM 502 provides a memory area required for the operation of the program. A ROM 503 holds the program for carrying out the above-described operation procedure. A hard disk drive (HDD) 504 acts as the support-function information holding unit 302 to hold support function information. A touch panel 505 is used for inputting various types of operations into the copier 102. A print unit 506 carries out printing on a print medium based on received print information and outputs the print medium. In the first embodiment, a communications device 507 is a wired LAN card. A bus 508 connects the above-described components of the copier 102 to each other.

The hardware configuration of the printer 103 will be described next with reference to FIG. 6. FIG. 6 shows the hardware configuration of the printer 103 according to the first embodiment of the present invention. A CPU 601 operates in accordance with a program that defines an operation procedure of the printer 103, as will be described below. A RAM 602 provides a memory area required for the operation of the program. A ROM 603 holds the program for carrying out the above-described operation procedure. A touch panel 604 is used for inputting various types of operations into the printer 103. A print unit 605 carries out printing on a print medium based on received print information and outputs the print medium. In the first embodiment, a communications device 606 is a wired LAN card. A bus 607 connects the above-described components to each other.

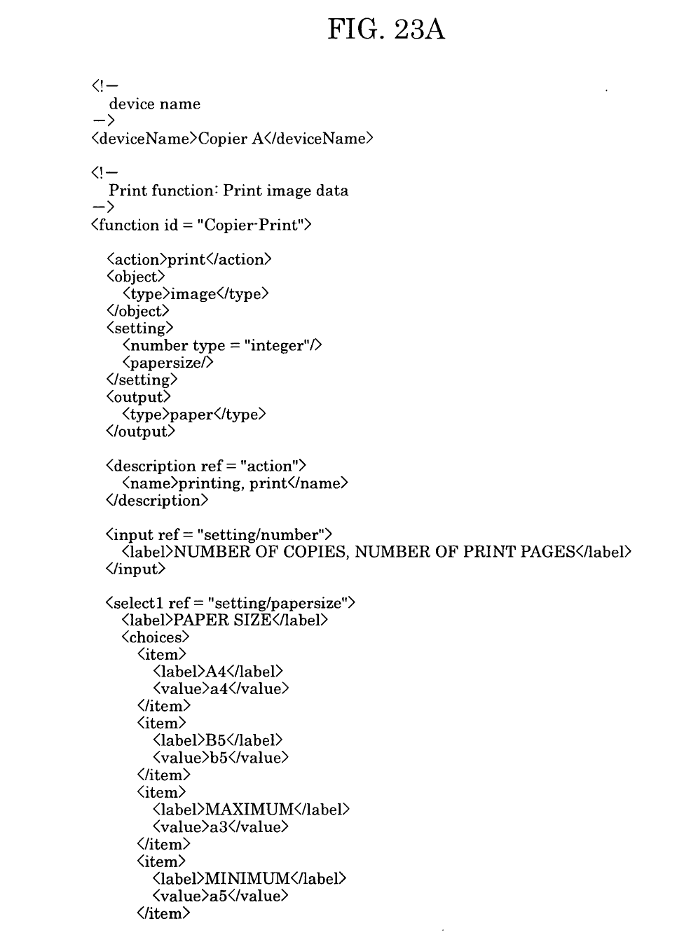

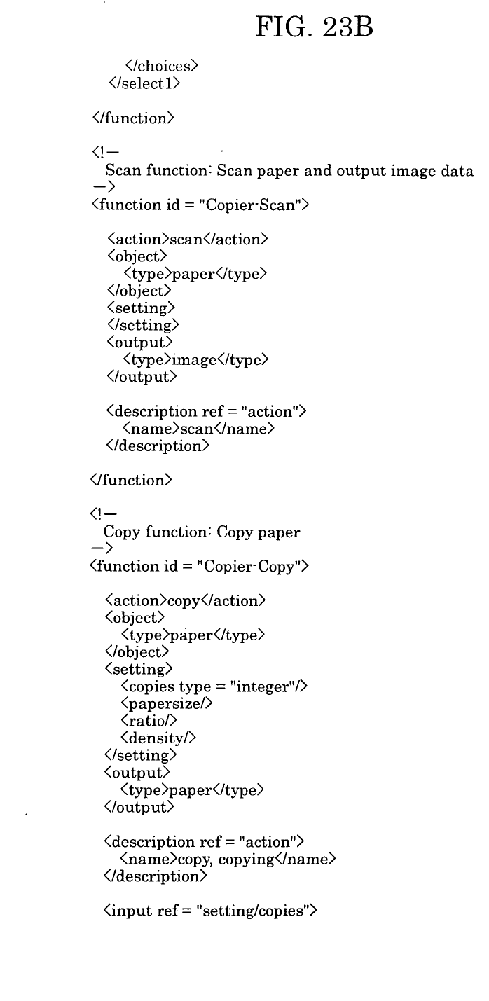

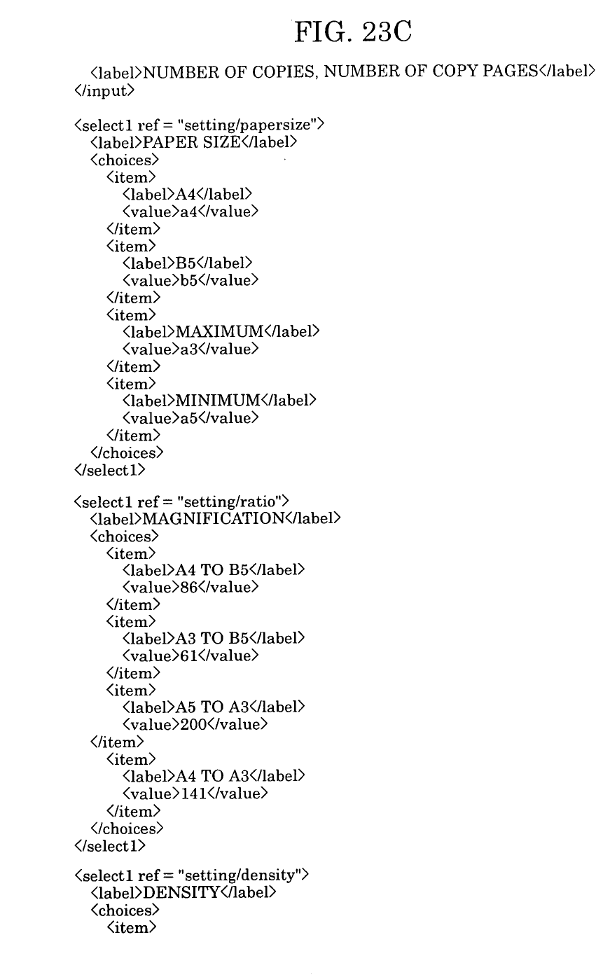

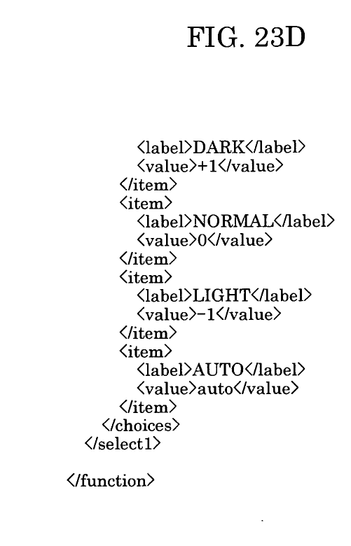

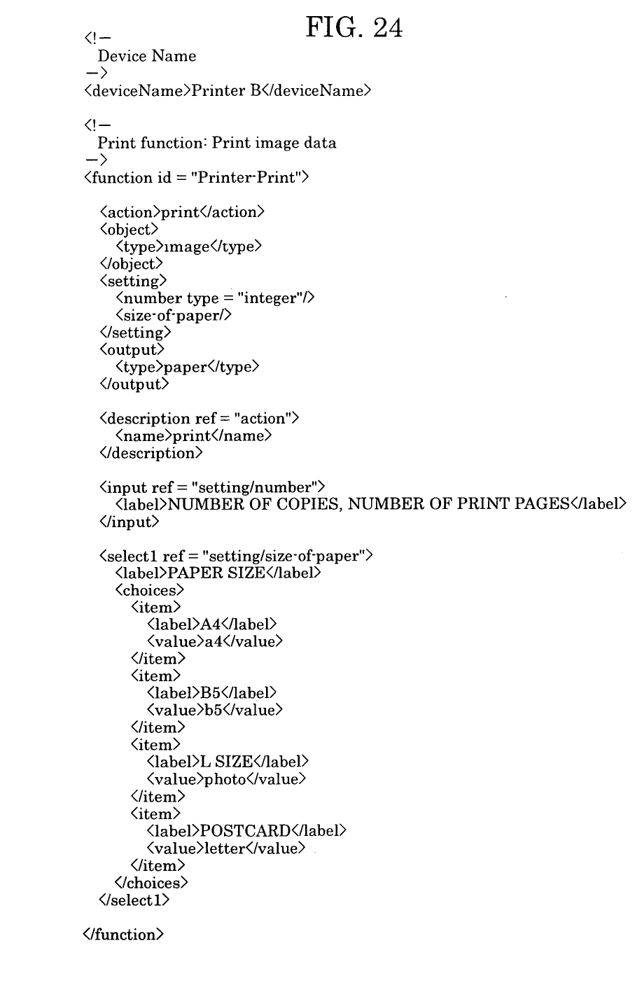

The function information held by the support-function information holding unit 302 of the copier 102 or the printer 103 will be described next. FIGS. 23A to 23D show an example of descriptions of function information of the copier 102, while FIG. 24 shows an example of descriptions of function information of the printer 103. This function information is described in the form of an XML document. Each element of the XML document will be described next.

<deviceName> Element

The name of a device is specified. In FIG. 23A, the name of the copier 102 is defined as “Copier A”.

<function> Element

One function of the device is specified. The function information that describes the function includes at least one of the operation type, an operation target, various types of setting parameters, and output information of an operational result.

<action> Element

The operation type is specified. For example, the description:
<action>print</action>
   indicates that the operation type of the function is printing of image data.
   <object> Element

The operation target is specified. The type of the operation target is specified in the <type> child element. For example, the description:

<object>

<type>image</type>

</object>

indicates that the target data of the function is image data.
<setting> Element

The various types of settings are specified. For example, the function “print” has setting items, such as the number of copies and an output paper size. The “type” attribute in an element corresponding to each item specifies a data type of the value of the item. For example, the description <number type=“integer”/> indicates that the <number> element has an integer value. The “type” attribute may also include “string” (a character string) as its value.

<output> Element

The information about output of an operational result is specified. The information about output of an operational result is specified in the <type>child element. For example, in the case of the function “print”, since paper is output, the following description is specified:

<output>

<type>paper</type>

</output>

The above-described elements describe the contents of the function. In addition, the support-function information holding unit 302 also holds user interface information to achieve the function on a user interface. This user interface information will be described next.

<description> Element

Additional information for the above-described <action>, <object>, <setting>, and <output> is specified. In particular, information for realizing these functions on UIs is specified. For example, in the following description:

<action>scan</action>
...
<description ref=“action”>

<name>scan</name>

</description>

the <description> element describes the <action> element and the <name> describes the name of the action. The above-described example indicates that the action is represented by “scan”. The “ref” attribute indicates for which element the statement is written. To specify the attribute, Xpath (http://www.w3.org/TR/xpath), which is a specification of the W3C (http://www.w3c.org), is used.
<input> Element

This is primarily a user interface component, by which each piece of data in the <setting> element is set, and indicates that the component is used to input data in a free form. The “ref” attribute indicates for which element the user interface component is used. The “ref” attribute is also specified with Xpath.

The child element <label> specifies a label of the user interface component. This can be also used for the representation of the user interface. This element complies with the specification of the <input> element of XForms by W3C (http://www.w3c.org), which is available on the Internet at http://www.w3.org/TR/xforms/slice8.html#ui-input.

For example, the following description:

<setting>

<copies/>

</setting>
...
<input ref=“setting/copies”>

<label>NUMBER OF COPIES</label>

</input>

indicates that the <copies/> element, which is data representing the number of copies, can be input by using a free-form user interface component having a label named “NUMBER OF COPIES”. In the case of a graphic user interface, the user interface component is, for example, a text box.
<select1> Element

This user interface component is primarily used to set each piece of data in the <setting> element through the user interface and is used to select one from a plurality of candidates. The “ref” attribute and the <label> element are identical to those for the <input> element. This element also complies with the specification of the <select1> element of XForms by W3C (http://www.w3c.org), which is available on the Internet at
http://www.w3.org/TR/xforms/slice8.html#ui-selectOne.

For example, the description:

<setting>

<papersize/>

</setting>
...
<select1 ref=“setting/papersize”>

<label>PAPER SIZE</label>
<choices>

<item>

<label>A4</label>
<value>a4</value>

</item>
<item>

<label>B5</label>
<value>b5</value>

</item>
<item>

<label>L SIZE</label>
<value>photo</value>

</item>
<item>

<label>POSTCARD</label>
<value>letter</value>

</item>

</choices>

</select1>

indicates that the <papersize/> element, which represents the paper size, has a label “PAPER SIZE” and can be input by using a selection-type user interface component in which one of “A4”, “B5”, “L SIZE”, and “POSTCARD” is selected. In the case of a graphic user interface, the selection-type user interface component may be a pull-down menu or a radio button. The <value> element is an internal data representation corresponding to each selection item.

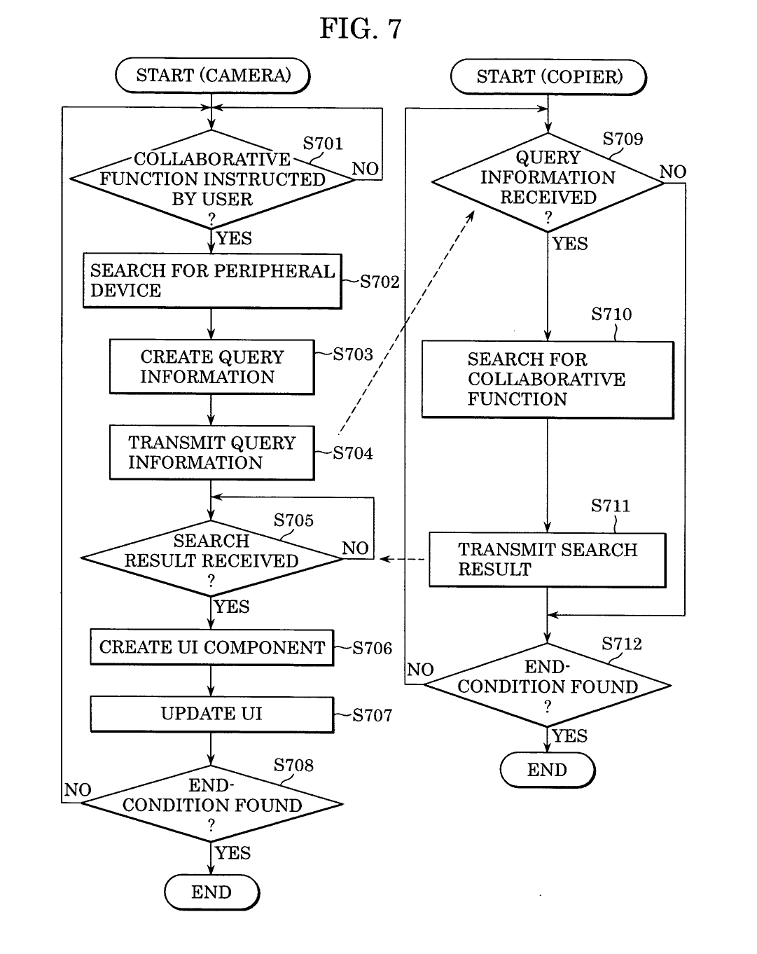

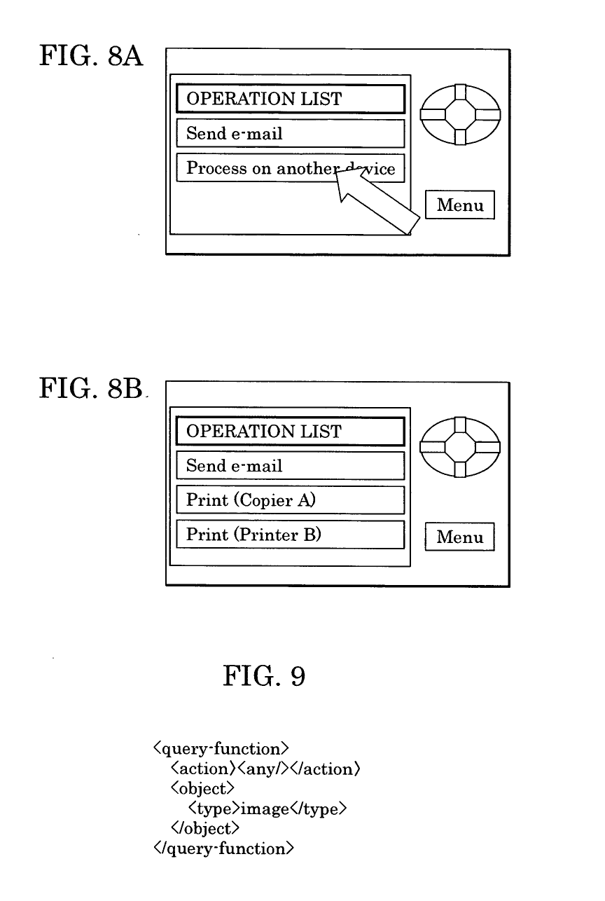

The operations of the digital camera 101, the copier 102, and the printer 103 according to the first embodiment will be described next with reference to FIG. 7. FIG. 7 is a flow chart of the operation of an information processing system according to the first embodiment of the present invention. In FIG. 7, it is assumed that, for example, the digital camera 101 displays one of the captured images on the LCD 404. The digital camera 101 determines whether or not a user instructs a collaborative function (step S701). When the user depresses a “Menu” button, a menu is displayed on a screen, as shown in FIG. 8A. The user's selection of “Process on another device” corresponds to instructing a collaborative function in step S701. If the user does not instruct the collaborative function (in the case of “NO” at step S701), the digital camera 101 waits until a collaborative function is instructed. However, if the collaborative function is instructed (in the case of “YES” at step S701), the process proceeds to step S702.

Upon receipt of the instruction, the peripheral-device searching unit 204 searches for peripheral devices capable of communicating with the digital camera 101 on the wired LAN 105 (step S702). Various searching methods can be used, therefore, a detailed description of a searching method is not provided herein. For example, devices that belong to a predetermined sub-net are searched for. Thus, for example, the copier 102, the printer 103, and other PCs are found.

Subsequently, the query-information creating unit 205 creates query information, namely, a query condition to search for a collaborative function (step S703). Since the digital camera 101 displays one of the captured images, “Process on another device” is a process to manipulate the image. Accordingly, the query-information creating unit 205 creates an XML document shown in FIG. 9 as the query information (query condition). In FIG. 9, the <any/> element indicates that the parent element can be of any value. Therefore, the query information (query condition) represents that a function having an operation target “image data” is searched for.

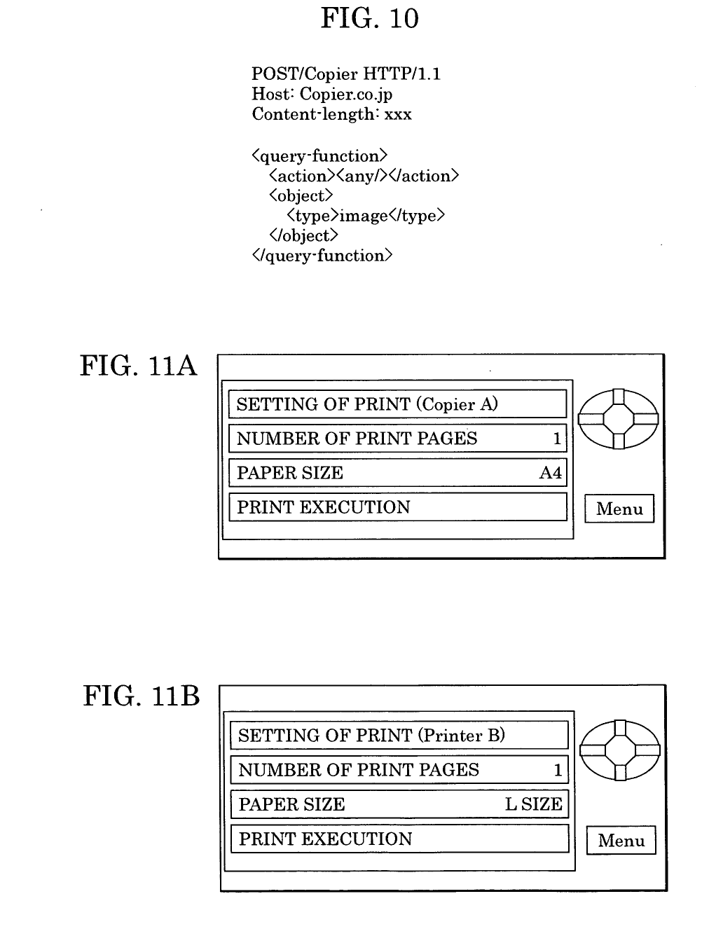

The query information is transmitted to all of the peripheral devices found by the peripheral-device searching unit 204 using an HTTP (hyper text transfer protocol) request, as shown in FIG. 10 (step S704). Then, it is determined whether or not a search result in response to the query information is received (step S705).

If a search result has not been received (in the case of “NO” at step S705), the digital camera 101 waits until it is received. However, if the search result is received (in the case of “YES” at step S705), the process proceeds to step S706.

The copier 102 determines whether or not query information from the digital camera 101 is received (step S709). If it is not received (in the case of “NO” at step S709), the copier 102 waits until it is received. If query information is received (in the case of “YES” at step S709), the process proceeds to step S710, where the copier 102 receives, for example, an HTTP request, as shown in FIG. 10. The query information, as shown in FIG. 9, is extracted from the HTTP request.

The collaborative-function searching unit 303 searches its own support functions held by the support-function information holding unit 302 for matching function information using the extracted query information as a key (step S710).

The function information of the copier 102 (FIGS. 23A to 23D) includes three <function> elements, namely, three functions. Among the functions, only a function having an id “Copier-Print” satisfies the query information shown in FIG. 9, that is, the query condition that the <action> element is any and the type of the <object> element is “image”.

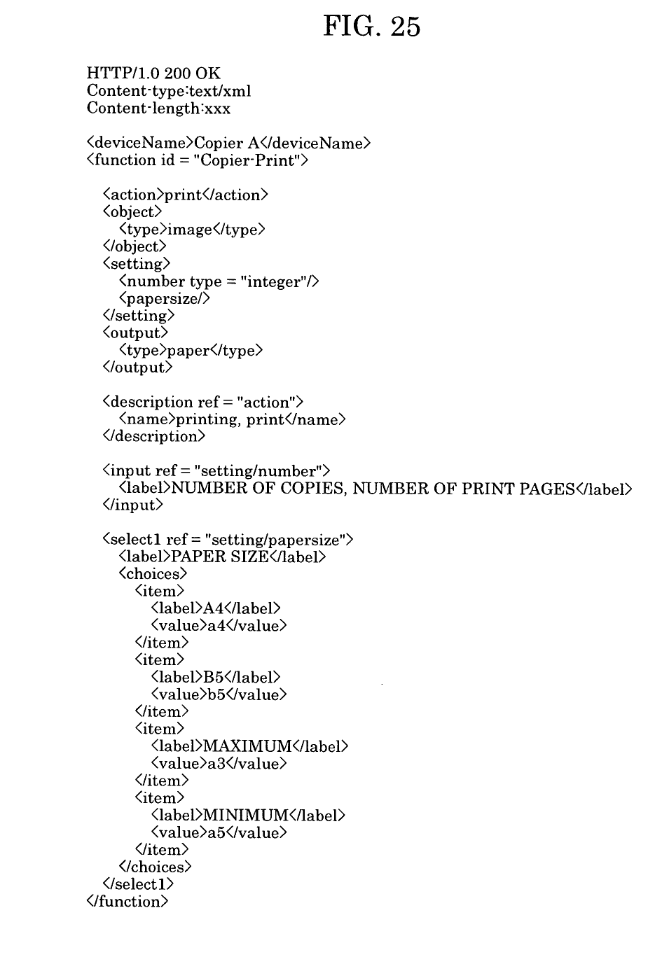

This means that the copier 102 can print the image from the digital camera 101. Accordingly, the collaborative-function-information transmitting unit 304 of the copier 102 creates a search result from only the content of the <function id=“Copier-Print”> element and transmits it along with the <deviceName> element in the form of an HTTP response, as shown in FIG. 25, to the digital camera 101 as a search result in response to the query information (step S711). A determination is then made in step S712 as to whether the copier 102 has found an end condition. If so, processing for the copier 102 ends. If not, processing for the copier 102 returns to step S709 to wait for receipt of query information from the digital camera 101.

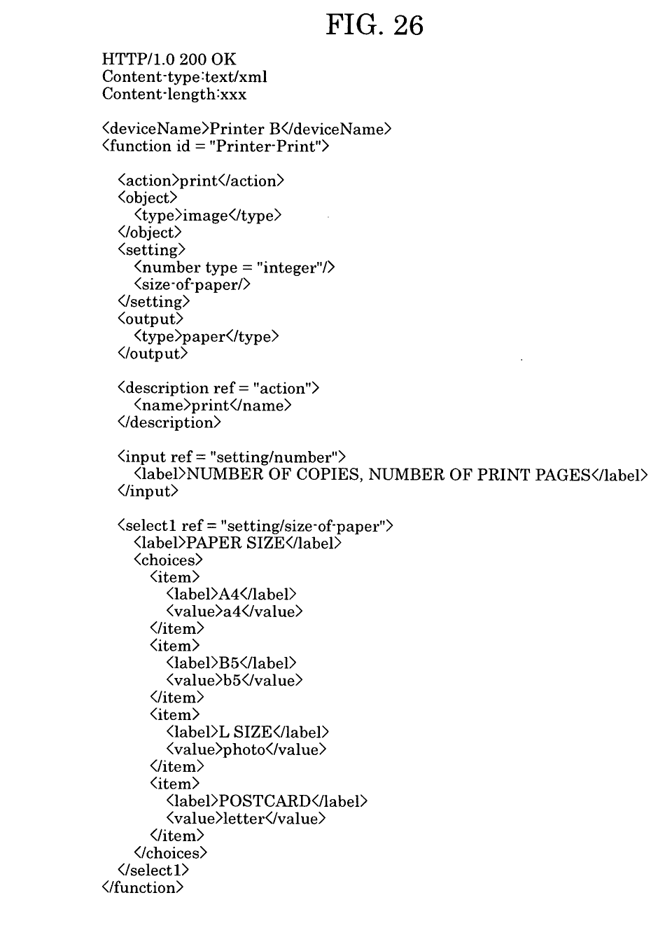

The printer 103 carries out the same operation as the copier 102. In this case, among the functions shown in FIG. 24, the printer 103 selects the <function id=“Printer-Print”> element, which matches the query information shown in FIG. 9, creates a search result from its content, and transmits it along with the <deviceName> element in the form of an HTTP response, as shown in FIG. 26, to the digital camera 101 as a search result in response to the query information.

When the communications unit 207 of the digital camera 101 receives the HTTP response, shown in FIG. 25, from the copier 102, the peripheral device function information acquiring unit 206 extracts the content of the <function id=“Copier-Print”> element, which is the search result of the collaborative function. The UI-component creating unit 203 then creates a user interface component from the user-interface-related information in the content for a user to use the collaborative function (step S706).

More specifically, the <deviceName> element suggests that the device name of the copier 102 is “Copier A”. Additionally, the <name> element of the <description> element pointing to the <action> element suggests that the action of the function can be represented by the name “printing” or “print”.

Accordingly, “print (Copier A)” is added in the menu list in FIG. 8A. However, the display is not limited thereto. One of the displays may be selected under certain conditions. Thus, the user interface component is added to the user interface of the digital camera 101 to launch the collaborative function “print an image with the copier 102” of the digital camera 101 and the copier 102.

The same process is carried out for a collaborative function search result from the printer 103, and therefore, “print (Printer B)” is added in the menu list. As a result, the user interface including the menu list is updated, as shown in FIG. 8B, by the UI updating unit 202 (step S707).

One more process is carried out at step S706, namely, user interface component creation, and at step S707, namely, user interface update. That is user interface creation for setting a variety of print parameters to print on the copier 102 and the printer 103. The information necessary for the setting is specified in the function information included in the search results from the copier 102 and the printer 103. A determination is then made in step S708 as to whether the digital camera 101 has found an end condition. If so, processing for the digital camera 101 ends. If not, processing for the digital camera 101 returns to step S701 to wait for an instruction for a collaborative function.

Herein, a mechanism for creating a user interface for setting the variety of print parameters for the copier 102 from the <function id=“Copier-Print”> element shown in FIG. 25 is described. The <input> element and the <select1> element are used to specify a user interface component that indicates each element in the <setting> element.

For example, the following description:

<input ref=“setting/number”>

<label>NUMBER OF COPIES, NUMBER OF PRINT
PAGES</label>

</input>

indicates that the <number/> element in the <setting> element can be represented by the label “NUMBER OF COPIES” or “NUMBER OF PRINT PAGES” and is set using a free-form user interface component. In addition, the description indicates that the setting value is an integer since the <number/> element has a “type” attribute and its value is “integer”. Furthermore, the description:

<select1 ref=“setting/papersize”>

<label>PAPER SIZE</label>
<choices>

<item>

<label>A4</label>
<value>a4</value>

</item>
<item>

<label>B5</label>
<value>b5</value>

</item>
<item>

<label>MAXIMUM</label>
<value>a3</value>

</item>
<item>

<label>MINIMUM</label>
<value>a5</value>

</item>

</choices>

</select1>

indicates that the <papersize/> element in the <setting> element can be represented by the label “PAPER SIZE” and is set using a user interface component of a selection type. The values in the selection list are “A4”, “B5”, “MAXIMUM”, and “MINIMUM”.

From this information, the UI-component creating unit 203 and the UI updating unit 202 create a user interface shown in FIG. 11A. Here, two items, “NUMBER OF PRINT PAGES” and “PAPER SIZE”, are displayed as the setting items. If “NUMBER OF PRINT PAGES” is selected by using an arrow key and the right arrow key or the left arrow key is then depressed, its integer value increases or decreases, respectively. If the “PAPER SIZE” is selected and the right arrow key or the left arrow key is then depressed, its value changes to “A4”, “B5”, “MAXIMUM”, and “MINIMUM”.

A character string “PRINT EXECUTION” at the bottom of the menu is obtained from the <name> element in the <description> element. If “PRINT EXECUTION” is selected and the center of the arrow keys is then depressed, the control-information transmitting unit 208 transmits the setting information and the current target image data to the copier 102 and the “print” is executed using the set values.

A user interface shown in FIG. 11A is launched when a user selects “print (Copier A)” and depresses the center of the arrow keys shown in FIG. 8B. Similarly, a user interface for carrying out a variety of settings for the printer 103 is created from the <function id=“Printer-Print”> element. FIG. 11B shows the user interface.

As described above, according to the first embodiment, the collaborative functions of the digital camera 101 and the copier 102 and of the digital camera 101 and the printer 103 can be dynamically found, and user interfaces for using the collaborative functions can be dynamically created. Accordingly, even when the digital camera 101 is not provided in advance with a function to print image data by itself on a copier or a printer and a user interface for the function, the digital camera 101 can create the appropriate user interface by itself when needed.

Similarly, when an unexpected collaborative function, such as a digital TV that can receive and display images as a peripheral device, appears, a collaborative function for the digital camera 101 to display an image therein on the digital TV and a user interface for the function can be dynamically created.

### Second Embodiment

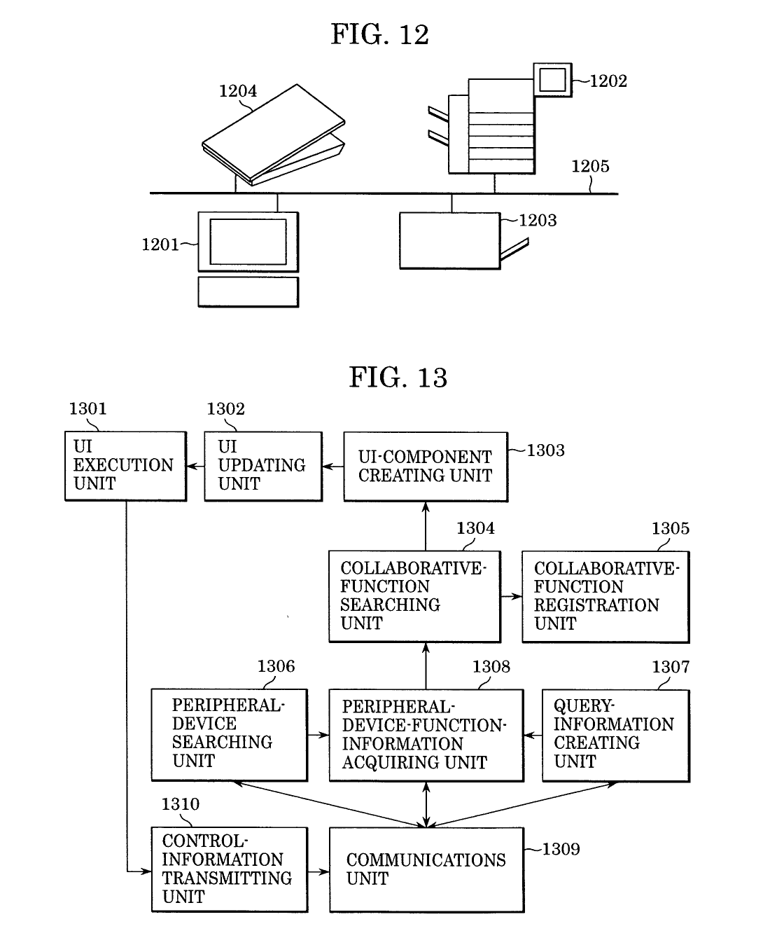

FIG. 12 is a block diagram of an information processing system according to the second embodiment of the present invention. As shown in FIG. 12, a PC 1201, a copier 1202, and a printer 1203 are connected to a wired LAN 1205. Additionally, a scanner 1204 is connected to the wired LAN 1205 and is operated by the PC 1201 via the wired LAN 1205. The information processing system includes the PC 1201, the copier 1202, the printer 1203, the scanner 1204, and the wired LAN 1205. According to the present invention, the PC 1201 functions as a user interface device capable of dynamically creating a user interface to operate a peripheral device on the wired LAN 1205, namely, the copier 1202, the printer 1203, or the scanner 1204. In FIG. 12, the LAN 1205 is a wired LAN. However, the LAN 1205 is not limited to a wired LAN. For example, the LAN 1205 may be replaced with a communications network which is one of the Internet, a WAN, a telephone network, a dedicated digital communication network, an ATM network, a frame relay network, a communication satellite network, a cable TV network, and a data broadcast wireless network to transmit and receive data. Alternatively, the LAN 1205 may be replaced with a combination of the above-described communication networks to transmit and receive data.

The functional structure of the PC 1201 will be described next with reference to FIG. 13. FIG. 13 is a diagram of the functional structure of the PC 1201 according to the second embodiment of the present invention. In the functional structure of the PC 1201, a user interface (UI) execution unit 1301 displays an output to a user and receives an input from the user. A UI updating unit 1302 updates a UI in cooperation with a peripheral device. A UI-component creating unit 1303 creates UI components corresponding to the collaborative function with the peripheral device. A collaborative-function searching unit 1304 searches the peripheral devices on the network for a function that can cooperate among the peripheral devices. A collaborative-function registration unit 1305 registers the function found by the collaborative-function searching unit 1304. A peripheral-device searching unit 1306 searches for a peripheral device capable of communicating with the PC 1201.

A query-information creating unit 1307 creates query information for searching the peripheral devices on the network for a function that can cooperate with the PC 1201 itself. As used herein, query information refers to information for the PC 1201, which is a user interface device, to search for a peripheral device for which the PC 1201 can dynamically create a user interface to operate it. For example, the query information includes at least one of the operation type of a peripheral device, an operation target, various types of setting parameters, and output information of an operational result.

A peripheral device function information acquiring unit 1308 transmits the query information created by the query-information creating unit 1307 to peripheral devices capable of communicating with the PC 1201 and acquires information on functions that a cooperative peripheral device can provide as a search result. A communications unit 1309 carries out communication on the wired LAN 1205 in the second embodiment. A control-information transmitting unit 1310 transmits to the peripheral device control information of the collaborative function received from a user operation.

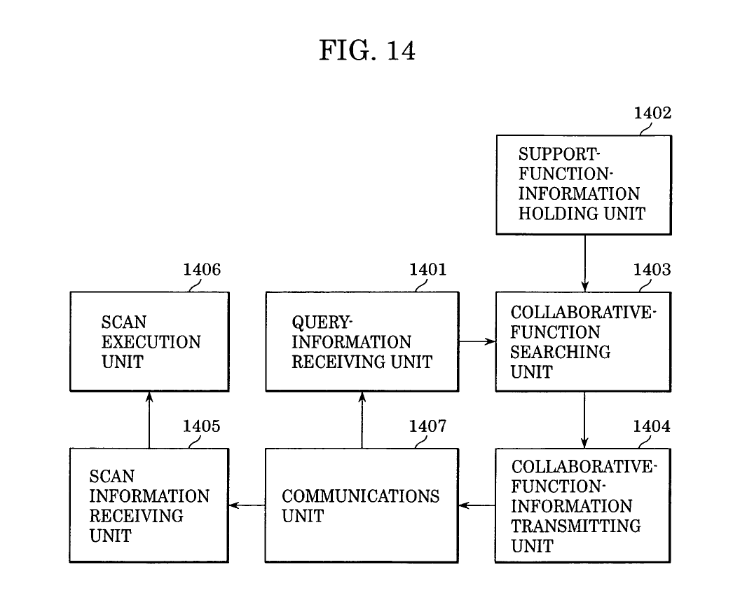

The functional structure of the scanner 1204 will be described next with reference to FIG. 14.

FIG. 14 is a diagram of the functional structure of the scanner 1204 according to the second embodiment of the present invention. A query-information receiving unit 1401 receives the query information created by the query-information creating unit 1306 from another device (the PC 1201 in the second embodiment) via a communications unit 1309. A support-function information holding unit 1402 holds function information of the scanner 1204. The function information includes, for example, at least one of the operation type, the operation target, various types of setting parameters, and output information of an operational result of the scanner 1204, which is a peripheral device. As well as the function information, the support-function information holding unit 1402 holds user interface information corresponding to the function. The user interface information is used for the user interface device to create a user interface for allowing the operation of the scanner 1204.

A collaborative-function searching unit 1403 searches for a function that can cooperate by matching the query information from another device (the PC 1201 in the second embodiment) received by the query-information receiving unit 1401 with the support function information held by the support-function information holding unit 1402. A collaborative-function-information transmitting unit 1404 transmits the search result from the collaborative-function searching unit 1403 to a sender of the query information (the PC 1201 in the second embodiment). A scan information receiving unit 1405 receives control information for controlling the scanner 1204 from the control-information transmitting unit 1310. A scan execution unit 1406 carries out a scan based on the scan information received by the scan information receiving unit 1405. A communications unit 1407 carries out communication on the wired LAN 1205 in the second embodiment.

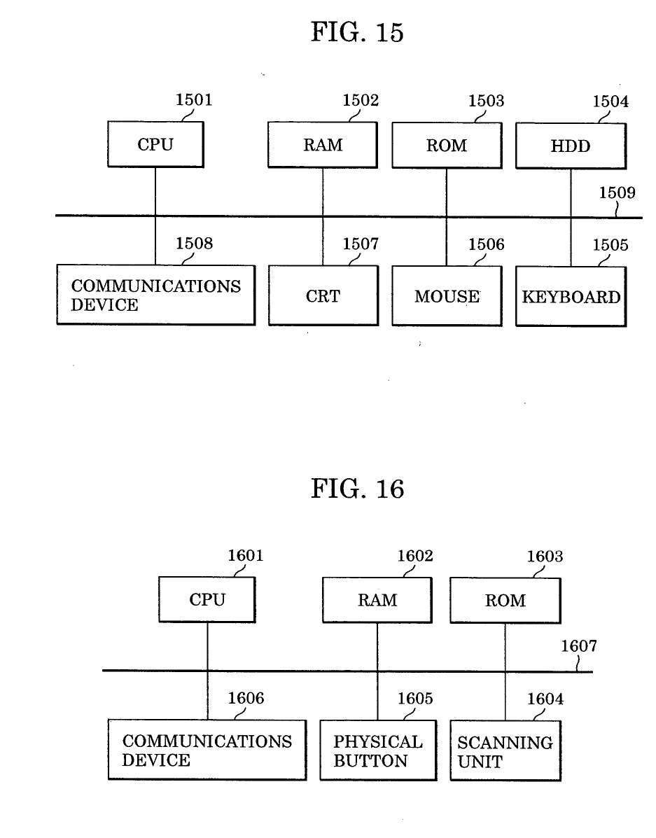

The hardware configuration of the PC 1201 will be described next with reference to FIG. 15. FIG. 15 shows the hardware configuration of the PC 1201 according to the second embodiment of the present invention. A CPU 1501 operates in accordance with a program that defines an operation procedure of the PC 1201, as will be described below. A RAM 1502 provides a memory area required for the operation of the program. A ROM 1503 holds the program for carrying out the above-described operation procedure. A hard disk drive (HDD) 1504 acts as the collaborative-function registration unit 1305 to hold the collaborative-function information. Input device(s), e.g., a keyboard and a pointing device, such as a keyboard 1505 and a mouse 1506, are provided for user data entry. A CRT display 1507 displays a graphic user interface. However, it may be a display of another type, such as an LCD display. In the second embodiment, a communications device 1508 is a LAN card. A bus 1509 connects the above-described components of the PC 1201 to each other.

The hardware configuration of the scanner 1204 will be described next with reference to FIG. 16. FIG. 16 shows the hardware configuration of the scanner 1204 according to the second embodiment of the present invention. A CPU 1601 operates in accordance with a program that defines an operation procedure of the scanner 1204, as will be described below. A RAM 1602 provides a memory area required for the operation of the program. A ROM 1603 holds the program for carrying out the above-described operation procedure. A scanning unit 1604 scans a target document. A physical button 1605 allows a user to operate the scanner 1204. In the second embodiment, a communications device 1606 is a LAN card. A bus 1607 connects the above-described components of the scanner 1204 to each other. The functional structures of the copier 1202 and the printer 1203 are identical to that described in FIG. 3 of the first embodiment. Additionally, the hardware configurations of the copier 1202 and the printer 1203 are identical to those described in FIGS. 5 and 6 of the first embodiment, respectively.

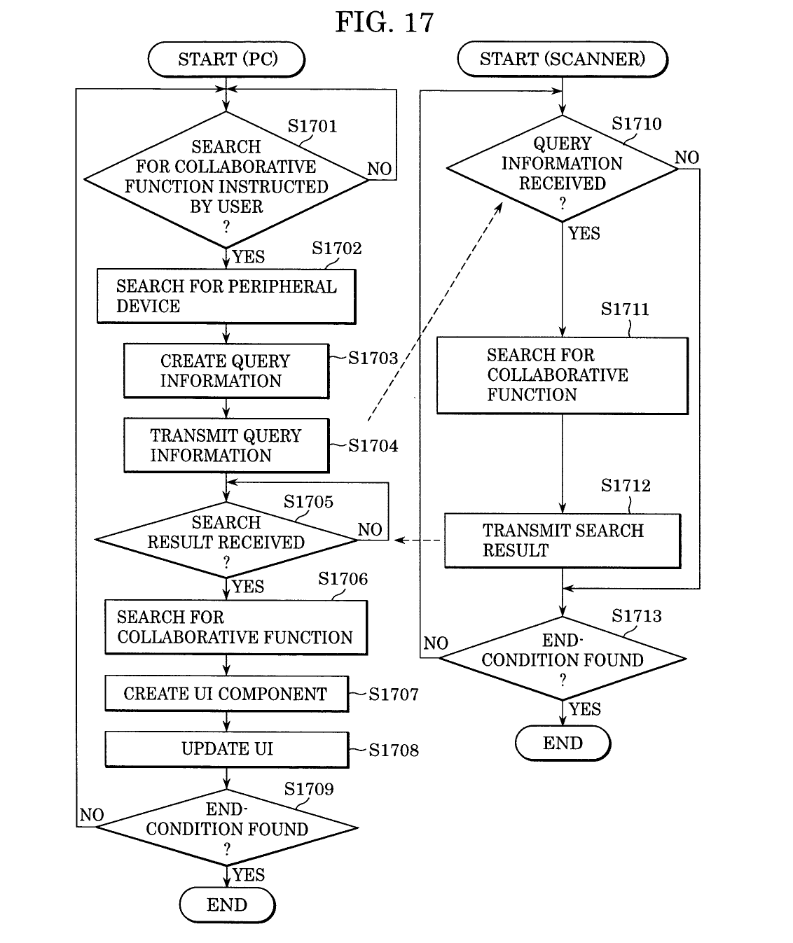

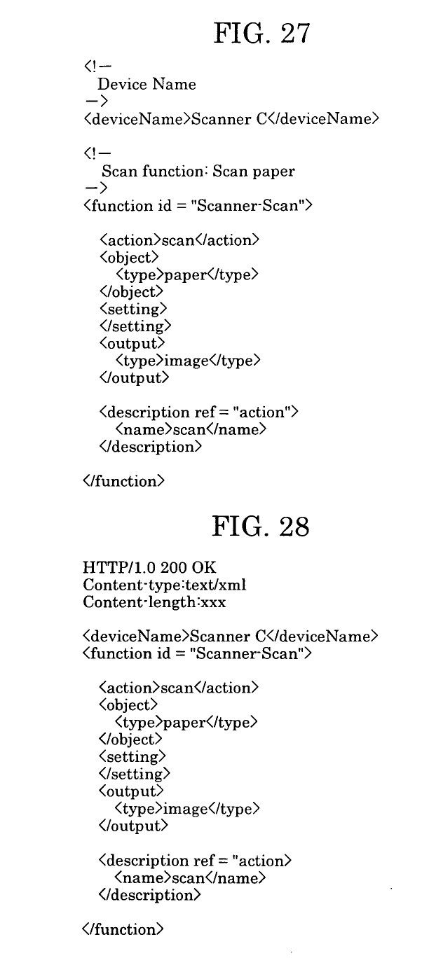

FIG. 27 shows support function information held by the support-function information holding unit 1402 of the scanner 1204. FIGS. 23A to 23D show function information on the copier 1202. FIG. 24 shows function information on the printer 1203. The operations of the PC 1201, the copier 1202, the printer 1203, and the scanner 1204 according to the second embodiment will be described next with reference to FIG. 17. FIG. 17 is a flow chart of the operation of the information processing system according to the second embodiment of the present invention.

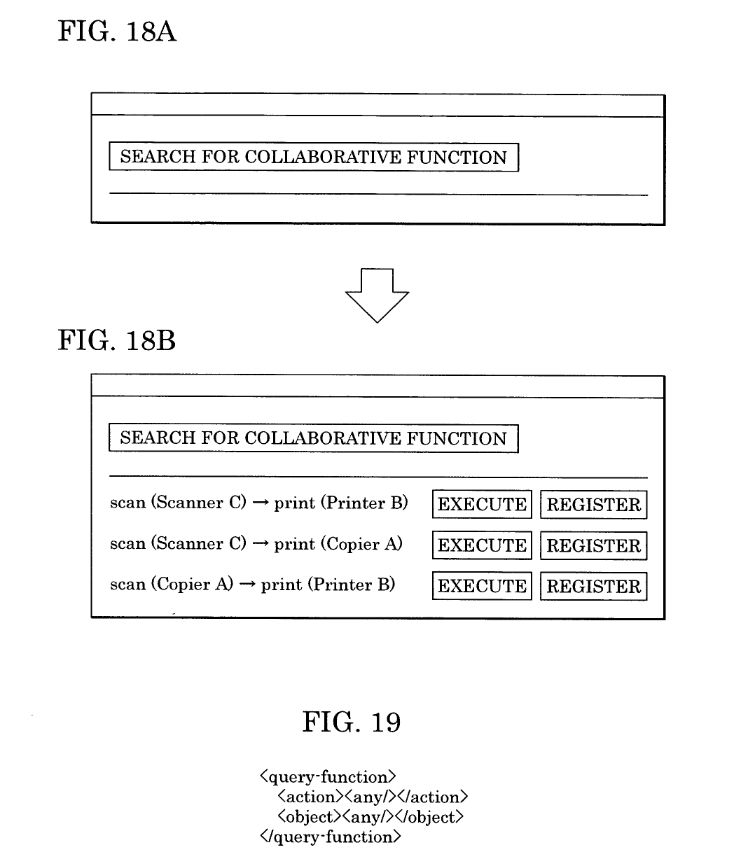

After a user starts an application, as shown in FIG. 18A, on the PC 1201, the application waits until the user depresses the “search for a collaborative function” button for determining whether or not a collaborative function exists (step S1701). If the user does not instruct to search for a collaborative function (in the case of “NO” at step S1701) at that time, the application waits until searching for a collaborative function is instructed. If searching for the collaborative function is instructed (in the case of “YES” at step S1701), the process proceeds to step S1702.

The peripheral-device searching unit 1306 searches for a communicable peripheral device on the wired LAN 1205 (step S1702). Various searching methods can be used, therefore, a detailed description of a searching method is not provided. For example, devices that belong to a predetermined sub-net are searched for. Thus, for example, the copier 1202, the printer 1203, the scanner 1204, and other PCs are found.

Subsequently, the query-information creating unit 1307 creates query information, namely, a query condition to search for a collaborative function (step S1703). The query-information creating unit 1307 creates an XML document, as shown in FIG. 19, as the query information (query condition). Since the search here does not specify the type and operation target of the function to be searched, both the <action> element and the <object> element have the <any/> child element.

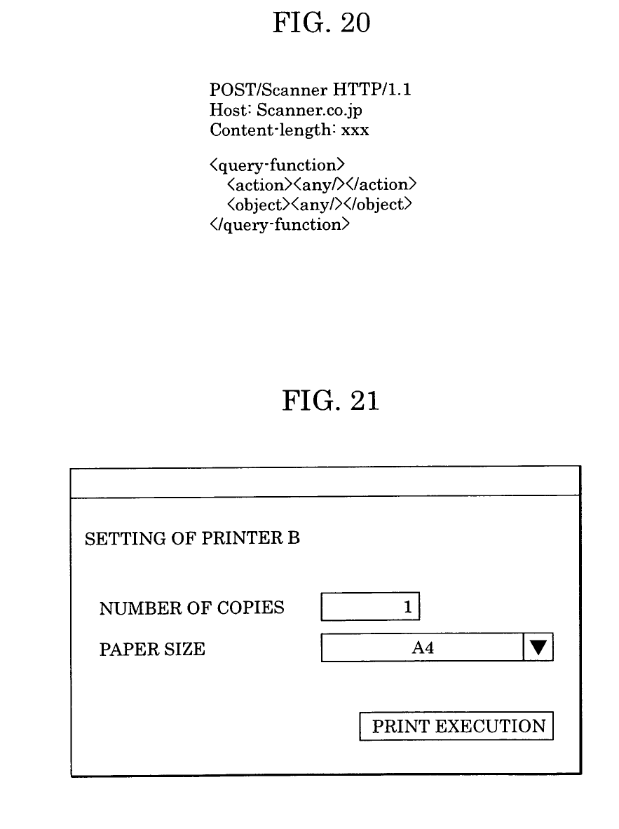

The query information is transmitted to all of the peripheral devices found by the peripheral-device searching unit 1306 using an HTTP request, as shown in FIG. 20 (step S1704). Then, it is determined whether or not a search result in response to the query information is received (step S1705).

If a search result has not been received (in the case of “NO” at step S1705), the application waits until it is received. However, if the search result is received (in the case of “YES” at step S1705), the process proceeds to step S1706.

The scanner 1204 determines whether or not query information is received (step S1710). If query information is not received (in the case of “NO” at step S1710), the scanner 1204 waits until query information is received. If query information is received (in the case of “YES” at step S1710), the process proceeds to step S1711, where the scanner 1204 receives, for example, an HTTP request, as shown in FIG. 20. The query information shown in FIG. 19 is extracted from the HTTP request.

The collaborative-function searching unit 1403 searches its own support functions held by the support-function information holding unit 1402 for matching function information using the extracted query information as a key (step S1711).

The function information of the scanner 1204 shown in FIG. 27 includes only one <function id=“Scanner-Scan”> element. This matches the query information shown in FIG. 19. Accordingly, the collaborative-function-information transmitting unit 1404 of the scanner 1204 creates a search result from only the content of the <function id=“Scanner-Scan”> element, and transmits it along with the <deviceName> element in the form of an HTTP response, as shown in FIG. 28, to the PC 1201 as a search result in response to the query information (step S1712). In step S1713 it is determined whether the scanner 1204 has encountered an end condition. If so, processing of the scanner 1204 ends. If not, processing of the scanner 1204 returns to step S1710. The copier 1202 and the printer 1203 carry out the same operation.

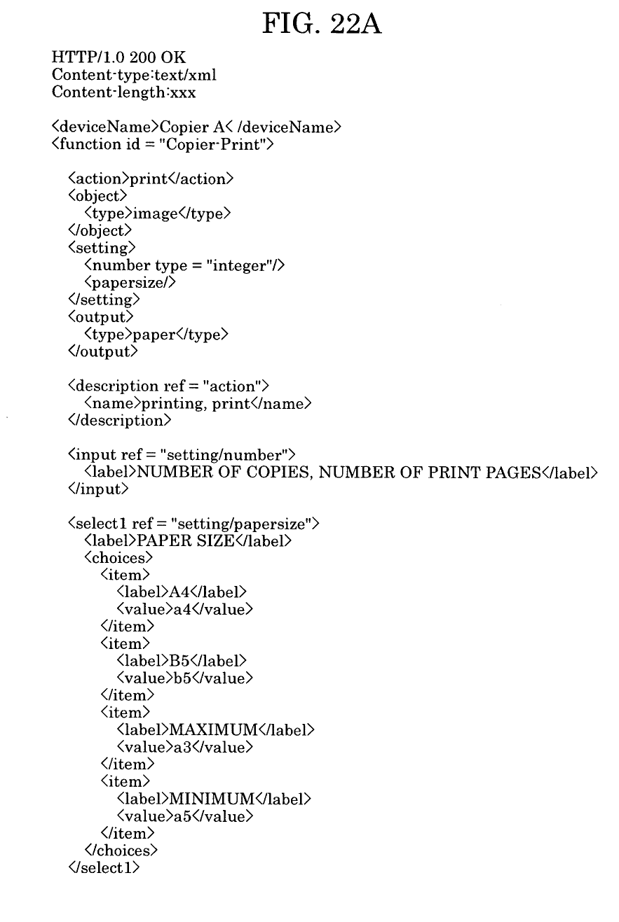

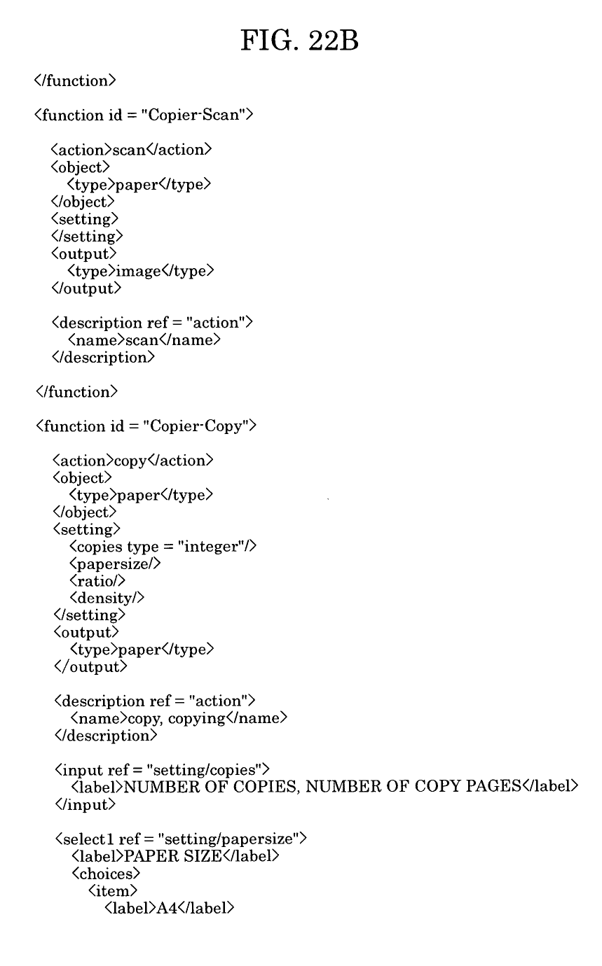

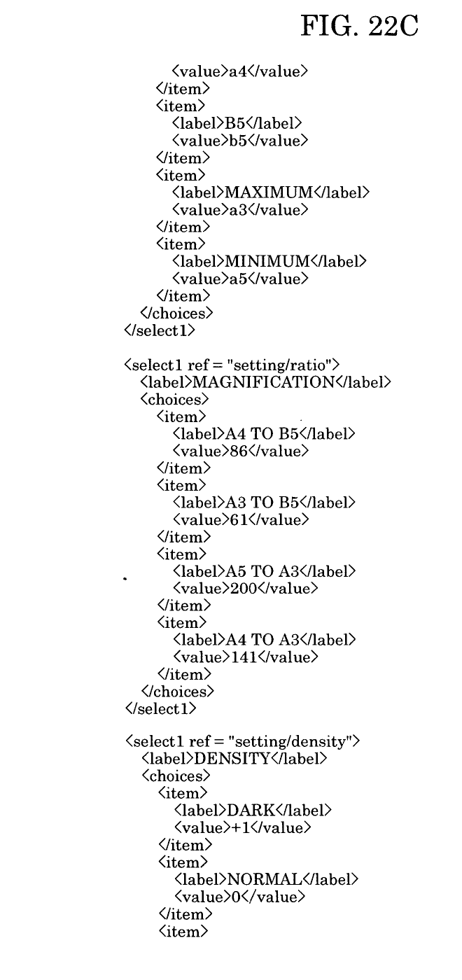

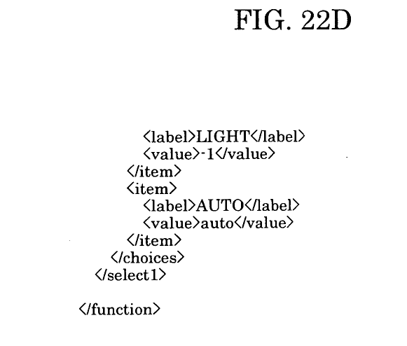

Among the functions specified in FIGS. 23A to 23D, all three functions, <function id=“Copier-Print”>, <function id=“Copier-Scan”>, and <function id=“Copier-Copy”>, match the query information shown in FIG. 19. Accordingly, the copier 1202 creates a search result from the content of these elements, and transmits it along with the <deviceName> element in the form of an HTTP response, as shown in FIGS. 22A to 22D, to the PC 1201 as a search result in response to the query information.

On the other hand, the printer 1203 transmits, among the functions shown in FIG. 24, the content of the <function id=“Printer-Print”>, that matches the query information shown in FIG. 19, and the <deviceName> element in the form of an HTTP response shown in FIG. 26 to the PC 1201 as a search result in response to the query information.

When the communications unit 1309 of the PC 1201 receives the HTTP responses from the peripheral devices, the peripheral device function information acquiring unit 1308 extracts the content of the <function> element, which is the search result of the collaborative function. The collaborative-function searching unit 1304 then searches for a combination of collaborative functions by matching the extracted content of the <function> elements with each other (step S1706). Additionally, the information on the combination of collaborative functions among the peripheral devices searched by the peripheral-device searching unit 1304 is registered in the collaborative-function registration unit 1305.

The combination of collaborative functions can be found by checking a value of the <output> element in the <function> element for one peripheral device against a <type> value of the <object> element in the <function> element for another peripheral device.

For example, here are the functions of the scanner 1204 and the printer 1203 represented by:

<function id=“Scanner-Scan”>

<action>scan</action>
<object>... </object>
<setting>... </setting>
<output>

<type>image</type>

</output>

...

</function>

and

<function id=“Printer-Print”>
<action>print</action>
<object>

<type>image</type>

</object>
<setting>... </setting>

...

</function>

In the <output> element and the <object> element, the <type> entries have the same value “image”.

This indicates that the printer 1203 can receive and print image data output from the scanner 1204 after scanning paper. From a user's point of view, this is a combined function referred to as a “copy”.

Thus, the UI-component creating unit 1303 creates a user interface (UI) component for a user to use the collaborative function among the peripheral devices found by the collaborative-function searching unit 1304 (step S1707).

More specifically, the <deviceName> elements shown in FIGS. 26 and 28 suggest that the device name of the scanner 1204 is “Scanner C” and the device name of the printer 1203 is “Printer B”.

Additionally, the <name> element of the <description> element pointing to the <action> element in <function id=“Scanner-Scan”> shown in FIG. 28 suggests that the action of the function can be represented by the name “scan”. Furthermore, the <name> element of the <description> element pointing to the <action> element in <function id=“Printer-Print”> shown in FIG. 26 suggests that the action of the function can be represented by the name “print”.

Therefore, the collaborative function is labeled “scan (Scanner C)→print (Printer B)” (step S1707).

In the same procedure, the collaborative functions between <function id=“Scanner-Scan”> and <function id=“Copier-Print”> and between <function id=“Copier-Scan”> and <function id=“Printer-Print”> are found. These two collaborative functions are respectively labeled “scan (Scanner C)→print (Copier A)” and “scan (Copier A)→print (Printer B)”. The UI updating unit 1302 reflects these functions on the user interface and updates it, as shown in FIG. 18B (step S1708).

One more process is carried out at step S1707, namely, a user interface component creation, and at step S1708, namely, a user interface update. That is user interface creation for setting a variety of parameters for scanning by the scanner 1204 and printing by the printer 1203 included in the collaborative function. The information necessary for the setting is specified in the function information of the peripheral devices.

More specifically, the <setting> element in the scan function <function id=“Scanner-Scan”> of the scanner 1204 has no content. Accordingly, no setting is required. In contrast, the <setting> element in the print function <function id=“Printer-Print”> of the printer 1203 has content. The <input> element and the <select1> elements specify user interface components pointing to each element in the <setting> element.

For example, the description:

<input ref=“setting/number”>

<label>NUMBER OF COPIES, NUMBER OF PRINT
PAGES</label>

</input>

indicates that the <number/> element in the <setting> element is represented by the label “NUMBER OF COPIES” or “NUMBER OF PRINT PAGES” and is set by using a free-form user interface component. In addition, since the <number/> element has a “type” attribute whose value is “integer”, the setting value is an integer.

Additionally, the description:

<select1 ref=“setting/size-of-paper”>
<label>PAPER SIZE</label>
<choices>

<item>

<label>A4</label>
<value>a4</value>

</item>
<item>

<label>B5</label>
<value>b5</value>

</item>
<item>

<label>L SIZE</label>
<value>photo</value>

</item>
<item>

<label>POSTCARD</label>
<value>letter</value>

</item>

</choices>
</select1>

indicates that the <size-of-paper/> element in the <setting> element is represented by a label “PAPER SIZE” and is set by using a user interface component of a selection type. The value of the selection list is one of “A4”, “B5”, “L SIZE”, and “POSTCARD”.

From this information, the UI-component creating unit 1303 and the UI updating unit 1302 create a user interface, as shown in FIG. 21. A text box is assigned to the item “NUMBER OF COPIES” and a pull-down menu is assigned to the item “PAPER SIZE” which is of a selection type. List items in the pull-down menu are “A4”, “B5”, “L SIZE”, and “POSTCARD”. After updating the UI (step S1708), a determination is made as to whether an end condition has been found in the PC 1201 (step S1709). If so, processing for the PC 1201 ends. If not, processing for the PC 1201 returns to step S1701.

As described above, according to the second embodiment, a user of the PC 1201 can dynamically find a collaborative function provided by a combination of any peripheral devices, namely, the copier 1202, the printer 1203, and the scanner 1204, and can dynamically create a user interface on the PC 1201 in order to use the function.

Accordingly, even when a user interface for a collaborative function among the peripheral devices is not incorporated in the PC 1201 in advance, for example, even when a newly purchased scanner 1204 is connected to the LAN, the collaborative functions “scan (scanner C)→print (printer B)” and “scan (scanner C)→print (copier A)” and user interfaces for the functions can be dynamically created on the PC 1201.

### Third Embodiment

In the above-described embodiments, a graphic user interface is employed. However, an audio interface using speech recognition and speech synthesis may be employed. As one of the examples, in a third embodiment, a speech input and output function is added to the user interface of the PC 1201 of the second embodiment.

The UI execution unit 1301 of the PC 1201 includes a speech input and output function and holds the following grammar of speech recognition in advance:

<grammar>

<rule id=“command”>

<one-of>

<item>search for a collaborative function</item>

</one-of>

</rule>

</grammar>

This grammar complies with the specification of SRGS (http://www.w3c.org/TR/speech-grammar/) by W3C and indicates that speech input “search for a collaborative function” is allowed. When a user, in the state shown in FIG. 18A, says “search for a collaborative function” as an input, the process proceeds to step S1702 shown in FIG. 17 and processes the subsequent steps.

In the second embodiment, three collaborative functions are found and are labeled “scan (Scanner C)→print (Printer B)”, “scan (Scanner C)→print (Copier A)”, and “scan (Copier A)→print (Printer B)”. These functions are reflected on the user interface, as shown in FIG. 18B.

In contrast, in the third embodiment, the UI-component creating unit 1303 further creates the following speech recognition grammar from these character strings:

<grammar>
<rule id=“composite-function”>
<one-of>
<item>scan by scanner C and print by printer B</item>
<item>scan by scanner C and print by copier A</item>
<item>scan by copier A and print by printer B</item>
</one-of>
</rule>
</grammar>

Herein, the value of each <item> element is created from the character strings “scan (Scanner C)→print (Printer B)”, “scan (Scanner C)→print (Copier A)”, and “scan (Copier A)→print (Printer B)”. This can be carried out by converting a character string “A(B)→C(D)” to “A by B and C by D”.

Thus, a user can start one of the found collaborative functions by uttering “scan by scanner C and print by printer B”.

Furthermore, the UI-component creating unit 1303 creates a speech recognition grammar that allows a speech input to create a user interface for setting a variety of parameters for the “scan” function of the scanner 1204 and the “print” function of the printer 1203. The information required for the setting is specified in the function information of each peripheral device.

The <setting> element in the scan function <function id=“Scanner-Scan”> of the scanner 1204 has no content. Accordingly, no setting is required.

In contrast, the <setting> element in the print function <function id=“Printer-Print”> of the printer 1203 has content. The <input> element and the <select1> elements specifies user interface components pointing to each element in the <setting> element. For example, the following description:

<input ref=“setting/number”>

<label>NUMBER OF COPIES, NUMBER OF PRINT
PAGES</label>

</input>

indicates that the <number/> element in the <setting> element is represented by the label “NUMBER OF COPIES” or “NUMBER OF PRINT PAGES” and is set by using a free-form user interface component. In addition, since the <number/>element has a “type” attribute whose value is “integer”, the setting value is an integer.

For this description, the UI-component creating unit 1303 creates the following speech recognition grammar:

<grammar>

<rule id=“number”>

<one-of>

<item>one</item>
<item>two</item>
<item>three</item>
<item>four</item>
<item>five</item>
<item>six</item>
<item>seven</item>
<item>eight</item>
<item>nine</item>
<item>ten</item>

</one-of>

</rule>

</grammar>

This grammar accepts the saying of numbers “one” to “ten”. In this example, the number is one of 1 to 10. However, it is easy to create a grammar to accept a number greater than 10.

On the other hand, the description:

<select1 ref=“setting/size-of-paper”>

<label>PAPER SIZE</label>
<choices>

<item>

<label>A4</label>
<value>a4</value>

</item>
<item>

<label>B5</label>
<value>b5</value>

</item>
<item>

<label>L SIZE</label>
<value>photo</value>

</item>
<item>

<label>POSTCARD</label>
<value>letter</value>

</item>

</choices>

</select1>

indicates that the <size-of-paper/> element in the <setting> element is represented by a label “PAPER SIZE” and is set by using a user interface component of a selection type. The value of the selection list is one of “A4”, “B5”, “L SIZE”, and “POSTCARD”.

For this description, the UI-component creating unit 1303 creates the following speech recognition grammar:

<grammar>

<rule id=“size-of-paper”>

<one-of>

<item>A4</item>
<item>B5</item>
<item>L size</item>
<item>postcard</item>

</one-of>

</rule>

</grammar>

This can be carried out by the following processes:
1. creating a <rule> element corresponding to the <select1> element
2. creating the <one-of> element corresponding to the <choices> child element
3. creating an <item> child element of the <one-of> element corresponding to the <label> child element of the <item> element, which is a child element of <choices> element, and assigning the value in the <label> element to a value in its <item> child element

Thus, the UI updating unit 1302 reflects the created speech recognition grammar on the user interface of the PC 1201. For example, the UI execution unit 1301 allows for the following interaction of speech.
User: “search for a collaborative function”
PC 1201: “three collaborative functions have been found”
User: “scan by scanner C and print by printer B”
PC 1201: “input number of copies”
User: “two”
PC 1201: “input paper size”
User: “L size”
PC 1201: “do you execute?”
User: “yes”

### Fourth Embodiment

In the above-described embodiments, an English user display interface is used. However, a user interface in any language may be used. Also, the language can be dynamically changed in accordance with a user or a user interface device.

In this case, the user interface device (the digital camera 101 in the first embodiment or the PC 1201 in the second embodiment) attaches information about the used language to query information and sends it to peripheral devices. Upon receipt of the information, the peripheral devices change user interface information contained in a collaborative-function search result in accordance with the used language.

### Fifth Embodiment

In the above-described embodiments, only “image”, which represents image data, is used for the type of the <object> and <output> elements, as shown in the example:

<object>

<type>image</type>

</object>

However, a variety of type information may be specified, such as “text”, which represents text data, and “audio”, which represents audio data. Additionally, by using the MIME type, the following expressions may be used:
image/gif (GIF image)
image/jpeg (JPEG image)
image/png (PNG image)
audio/mp3 (MP3 data)
mov/mp4 (MPEG4 data)
text/plain (plain text)
text/html (HTML text)
text/xml (XML text)
   etc.

### Sixth Embodiment

In the above-described embodiments, the function information of a peripheral device is described with XML. However, it is to be understood that the function information may be described in any other format.

### Seventh Embodiment

In the second embodiment, the digital camera 101 is connected to the network via a wireless LAN. However, it is to be understood that the interface may be any other wireless connection interface including Bluetooth.

### Eighth Embodiment

In the second embodiment, the description of the speech recognition grammar complies with the specification of SRGS (http://www.w3c.org/TR/speech-grammar/) by W3C. However, it will be appreciated that any other grammar description form can be used.

### Other Embodiments

In the above-described embodiments, the program is held by a ROM. However, it is not limited to a ROM. Alternatively, the program may be held by any other recording medium. Furthermore, the above-described embodiments may be realized by a circuit providing the same operations.

As described above, according to the present invention, a collaborative function between a user interface device and a peripheral device on a network can be dynamically found and a user interface can be dynamically created on the user interface device to operate the collaborative function. Accordingly, a user can operate and use even an unexpected collaborative function that is not incorporated in the user interface device in advance.

As described above, the embodiments are described in detail. However, the present invention can be achieved by an embodiment in the form of, for example, a system, a device, a method, a program, and a recording medium. More specifically, the present invention may be applied to a system including a plurality of apparatuses or may be applied to a device including one apparatus.

In addition, the present invention includes the case where a program of software that achieves the functions of the above-described embodiments is supplied to a system or a device directly or remotely and a computer in the system or the device reads and executes program code in the supplied software. Note that, in the above-described embodiments, the program corresponds to a flow chart in each drawing.

Accordingly, the program code itself installed in a computer that executes the functions of the present invention also achieves the present invention. That is, the present invention includes a computer program that achieves the functions of the present invention.

In this case, the program may be in the form of object code, a program executed by an interpreter, and script data supplied to an OS (operating system) as long as the program has the above-described functions.

The recording medium for supplying the program includes, for example, a floppy disk, a hard disk, an optical disk, a magneto optical (MO) disk, a CD-ROM (compact disk—ROM), a CD-R (compact disk—recordable), a CD-RW (compact disk—rewritable), a magnetic tape, a nonvolatile memory card, a ROM, and a DVD (digital versatile disk), e.g., a DVD-ROM or a DVD-R.

Alternatively, the program may be supplied by accessing a home page on the Internet using a browser in a client computer and downloading the computer program of the present invention or a compressed file including an auto-install function from the home page to a recording medium, such as a hard disk. Furthermore, program code of the program of the present invention may be divided into a plurality of files, which may be downloaded from different home pages. In other words, a WWW (world wide web) server that allows a plurality of users to download a program file that achieves the functions of the present invention is also included in the present invention.

Additionally, the program according to the present invention can be encrypted and stored into a recording medium, such as a CD-ROM, to deliver it to users. A user who satisfies a predetermined criterion can download key information for decrypting the encryption from a home page on the Internet. By using the key information, the user can install the encrypted program in a computer and can execute the program.

Additionally, in addition to achieving the functions of the above-described embodiments by the computer executing the readout program, the functions of the above-described embodiments can be achieved by a process that an OS running on the computer executes some of or all of the effective functions in response to instructions of the program.

Furthermore, the functions of the above-described embodiments can be achieved by a process in which, after a program read from a recording medium is stored in an add-on expansion board inserted in a computer or a memory of an add-on expansion unit connected to a computer, the add-on expansion unit or a CPU in the add-on expansion unit executes some of or all functions described in the above-described embodiments.

While the present invention has been described with reference to exemplary embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Application No. 2003-413836 filed Dec. 11, 2003, which is hereby incorporated by reference herein.

1. An information processing device comprising:
transmitting means for transmitting query information for searching for a collaborative function with a peripheral device to the peripheral device;
receiving means for receiving a search result for the query information from the peripheral device;
creating means for creating a user interface component to operate the collaborative function with the peripheral device based on the search result received by the receiving means; and
update means for updating the user interface based on the user interface component created by the creating means.

2. The information processing device according to claim 1, wherein the query information includes at least one of an operation type, an operation target, various types of setting parameters, and output information of an operational result of the peripheral device.

3. The information processing device according to claim 1, wherein the user interface component created by the creating means is a user interface component for starting the collaborative function with the peripheral device in the search result received by the receiving means and a user interface component for setting various types of parameters of the collaborative function.

4. The information processing device according to claim 1, further comprising execution means for executing the user interface, wherein the update means adds the user interface component created by the creating means to the user interface executed by the execution means.

5. The information processing device according to claim 4, wherein the execution means executes a graphic user interface and the user interface component created by the creating means is a user interface component for the graphic user interface.

6. The information processing device according to claim 4, wherein the execution means executes an audio user interface and the user interface component created by the creating means is a user interface component for the audio user interface including a speech recognition grammar.

7. The information processing device according to claim 1, further comprising:
searching means for searching for a combination of functions being cooperative among peripheral devices on the network; and
registration means for registering information about the combination of functions being cooperative among the peripheral devices on the network;
wherein the user interface component created by the creating means is a user interface component to operate a plurality of the peripheral devices based on the search result received by the receiving means and the information registered by the registration means.

8. An information processing device for accepting an operation from a user interface device connected via a network, the information processing device comprising:
receiving means for receiving query information for searching for a collaborative function with the user interface device from the user interface device on the network;
holding means for holding function information describing support functions of the information processing device in association with corresponding user interface information;
searching means for searching for a combination of functions being cooperative with the user interface device based on the query information received by the receiving means by referring to holding means; and
transmitting means for transmitting, to the user interface device on the network, information about the combination of functions being cooperative with the user interface device searched by the searching means.

9. The information processing device according to claim 8, wherein the function information includes at least one of an operation type, an operation target, various types of setting parameters, and output information of an operational result of the information processing device.

10. The information processing device according to claim 9, wherein the searching means searches for the combination of functions being cooperative with the user interface device by matching the query information received by the receiving means with the function information held by the holding means for each of the operation type, the operation target, the various types of setting parameters, and the output information of the operational result.

11. An information processing system comprising:
a user interface device; and
a peripheral device connected to the user interface device via a network;
wherein the user interface device comprises:
query-information creating means for creating query information for searching for a collaborative function with the peripheral device;
user interface device transmitting means for transmitting the query information to the peripheral device on the network;
user interface device receiving means for receiving a search result for the query information from the peripheral device on the network;
creating means for creating a user interface component to operate the collaborative function with the peripheral device based on the search result received by the user interface device receiving means; and
update means for updating the user interface based on the user interface component created by the creating means, and the peripheral device comprises:
peripheral device receiving means for receiving the query information from the user interface device on the network;
holding means for holding function information describing support functions of the information processing device in association with corresponding user interface information;
searching means for searching for a combination of functions being cooperative with the user interface device based on the query information received by the peripheral device receiving means by referring to the holding means; and
peripheral device transmitting means for transmitting, to the user interface device on the network, information about the combination of functions being cooperative with the user interface device as a search result searched by the searching means.

12. The information processing system according to claim 11, further comprising:
searching means for searching for a combination of functions being cooperative among the peripheral devices on the network based on the search result received by the user interface device receiving means; and
registration means for registering information on the combination of functions being cooperative among the peripheral devices on the network searched by the searching means;
wherein the creating means creates a user interface component to operate a plurality of the peripheral devices based on the search result received by the user interface device receiving means and the information registered by the registration means.

13. A method for controlling an information processing device, the method comprising steps of:
transmitting query information for searching for a collaborative function with a peripheral device to the peripheral device;
receiving a search result for the query information from the peripheral device;
creating a user interface component to operate the collaborative function with the peripheral device based on the search result received; and
updating the user interface based on the user interface component created.

14. A program comprising program code for performing steps of claim 13.

15. A method for controlling an information processing device for accepting an operation from a user interface device connected via a network, the method comprising steps of:
receiving query information from the user interface device on the network for searching for a collaborative function with the user interface device;
searching for a combination of functions being cooperative with the user interface device based on the query information received by referring to a recording medium for recording function information describing support functions of the information processing device in association with the corresponding user interface information; and
transmitting information about the combination of functions being cooperative with the user interface device searched to the user interface device on the network.

16. A program comprising program code for performing steps of claim 15.
